(19) United States
(12) Patent Application Publication
(10) Pub. No.: US 2006/0097847 A1
(43) Pub. Date: May 11, 2006

(54) Identification module, identification system comprising a plurality of identification modules and sports shoe

(75) Inventors: Alfonsus Maria Bervoets, Bentveld (NL); Marcel Schaap, Santpoort-Zuid (NL)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: AMB IT Holding B. V., Heemstede (NL)

(21) Appl. No.: 10/973,088

(22) Filed: Oct. 25, 2004

(51) Int. Cl. H04Q 5/22; G05B 23/02; G06K 7/00; G08B 13/14

(52) U.S. Cl. 340/10.1; 340/10.5; 340/3.2; 340/572.1; 235/436

(57) ABSTRACT

The invention relates to an identification module to identify a passive RFID tag passing said identification module, the identification module comprising an antenna arrangement adapted to transmit an activation signal to activate the passive RFID tag and to trigger a response signal from the passive RFID tag; a decoder unit adapted to process said response signal from the passive transponder to obtain identification data of the passive RFID tag; a communication unit adapted for data exchange with another identification module and at least one data output for the identification data of the passive RFID tag. The invention further relates to an identification system comprising a plurality of such identification modules and a sports shoe comprising an integrated passive RFID tag.

### FIELD OF THE INVENTION

The invention relates to an identification module and an identification system comprising a plurality of such identification modules. More specifically, the invention relates to an identification module and an identification system comprising a plurality of such identification modules, wherein the identification module is arranged to identify a passive RFID tag passing said identification module. The identification module and identification system can advantageously be applied during sports events, in particular sports timing with a high number of participants, such as marathons. Finally the invention relates to a sports shoe particularly adapted to be used in sports events applying the identification module or system.

### BACKGROUND OF THE INVENTION

In terms of numbers of competitors, running races are the largest sport events known to man. The United States e.g. yearly has no less than twenty full-marathons that each attract over twenty-thousand participants. The total number of participants to US marathons in 2002 is estimated to be 450,000. While this is impressive by itself, full marathons only make up for a small percentage of the total running event participation. The estimated number of running event participants in the United States in 2002 is 7,746,000.

FIGS. 1A and 1B show finish time distributions per minute m and per second s of the New York City marathon of 2002, wherein # stands for the number of participants. The figures depict 31,830 finishing participants, the winner setting a time of 2:08m. The busiest minute at the finish line was the 257th (4:17m) after race start, with 304 passings. FIG. 1B shows the same data grouped per second. The maximum number of passings in a single second is 14. In conclusion, mass events have a high likelihood of simultaneous passings of participants.

These figures clearly indicate that there is a considerable need for sports timing.

Time registration used to be done manually by people with stopwatches and notepads. As a result, official times were inaccurate and incomplete. Many events only recorded official timing for the first number of finishers.

Later, automatic timing systems were developed. As an example, WO 02/012920 discloses a single wire loop type antenna in an upturned U-configuration that is positioned in a vertical plane over a track passed by participants of a running event. The participants wear custom made electronic tags attached to the chest portion of their shirts. A disadvantage of this system is that the loop antenna power would be impractically high to activate the tags. Antenna's transmitting such radiation power are usually prohibited without a license. Further, in order to receive sufficient activation energy, the tags worn by the participants should be large. Finally, these tags are custom made, which is particularly inefficient and costly for mass events.

In a different approach ChampionChip® (www.championchip.com), a company based in the Netherlands, offers rubber mats to be placed on the track and upon which the participants should step for registration. The mats typically have dimensions of 200×100 centimeters and have an antenna to activate passive, low frequency, tags worn by participants and to detect response signals of the transponders passing the mat. The tags can be attached to the laces of the shoe of the participant. The mats are offered together with controllers that should be connected to the mats. The controllers comprise RFID readers to generate an activation signal for the transponders and to receive the response signals for interpretation. A disadvantage of this approach is that the tags of the participants are LF tags and accordingly provide a coarse resolution that makes them unsuitable for mass events. Further, a separate reader is provided for each mat, making the system complicated and not scalable.

### SUMMARY OF THE INVENTION

It is an object of the invention to obtain an identification system that reduces or eliminates one or more of the above mentioned disadvantages.

It is a further object of the invention to provide a mass event sports timing system, wherein participants can use high frequency passive tags.

In an aspect of the invention, an identification module is proposed to identify a passive RFID tag passing said identification module wherein said identification module comprises an antenna arrangement to transmit an activation signal to activate said passive RFID tag and to trigger a response signal from said passive RFID tag; a decoder unit arranged to process said response signal from said passive transponder to obtain identification data of said passive RFID tag; a communication unit arranged for data exchange with another identification module, and at least one data output for said identification data of said passive RFID tag. In contrast to the ChampionChip® system wherein the mat outputs the response signal from the LF tag to an external reader, the identification module according to this aspect of the invention first analyses the response signal and transfers the result to a computer. That is to say that the module itself includes an RFID-reader. By integrating the decoder in the identification module, the identification data itself can be transmitted to a computer unit. Further, the identification module includes a communication unit for data exchange with another identification module. This communication unit may e.g. be applied for tuning the performance with other identification module and/or for data transmission including the identification data of the passing tag between identification modules. The data transmission can be performed wirelessly from each identification module to the computer unit or by hopping between various present identification modules to the computer unit. Consequently, a scalable identification system is obtained as such identification modules can be easily combined. The passive RFID tag preferably is a high frequency passive RFID tag, of e.g. 13.56 MHz.

In another aspect of the invention, the identification module comprises a synchronization unit to exchange synchronization data with other identification modules for transmitting said activation signal to generate a resulting activation field. Generally, the activation field is a magnetic field here. By setting the phase lag between the activation signals of individual identification modules, the resulting activation field for a plurality of such identification modules can be optimized for communication with the tags.

In another aspect of the invention, the identification module further comprises a timer and a memory module to store said identification data. This memory module allows the identification module to temporarily store the response signal or identification data of a tag and time stamp it when response signals are received. The identification data then can be transmitted to a computer unit when no or only few response signals are received.

In an important aspect of the invention, the identification module is a flat element or carrier, such as a tile or mat, adapted to be positioned on the ground and to be stepped on. This provides a suitable shape of the identification module for mass running events. The dimensions of the flat elements are preferably in a range of 20×20 centimeters to 100×100 centimeters, e.g. 50×50 centimeters. It should be appreciated that the flat elements do not necessarily have a square shape, but may be rectangular, hexagonal, etc. or have an irregular shape. The flat elements may e.g. have the shape of jigsaw puzzle pieces to form an identification system. This has the advantage that correct positioning of the identification modules with respect to each other is accomplished automatically.

The thickness of the flat elements should preferably not exceed 5 centimeters. This is particularly true for flat elements that are positioned on a track to be stepped on. It is however noted that the identification module may also be buried into a surface of e.g. a running track in which case the thickness of the module is less relevant.

The flat element may comprise mechanical connection means to connect said flat element to one or more other identification modules. As the system is a scalable system, often multiple identification modules are connected to each other to prevent sliding of the modules when multiple participants pass and contact the modules with their feet.

It should further be appreciated that the identification modules are not necessarily positioned on the ground. The identification modules may be positioned in any orientation, e.g. hanging vertically, as long as communicative connection with the passing tags can be accomplished.

In an aspect of the invention, an identification system is proposed to identify a passive RFID tag passing said system, said identification system comprising a plurality of identification modules, wherein at least one identification module comprises an antenna arrangement to transmit an activation signal to activate said passive RFID tag and to trigger a response signal from said passive RFID tag and wherein each identification module comprises a decoder unit arranged to process said response signal from said passive RFID tag to obtain identification data of said tag; a communication unit arranged for data exchange with another of said plurality of identification modules, and at least one data output for said identification data of said passive RFID tag. Accordingly, a scalable identification system is obtained.

In an aspect of the invention, the identification system comprises a plurality of identification modules for transmitting activation signals and the communication unit comprises a synchronization unit arranged to synchronize transmission of said activation signal with activation signals of other identification modules of said plurality of identification modules. Consequently an adequate activation field for passing transponders can be accomplished by synchronizing the activation signals of the various identification modules. Preferably, phase lags between the activation signals of adjacent identification modules include the range of 60-90°. A phase lag in this range results in a substantially homogeneous activation field. A phase lag of 0° (in phase) or 180° (phase inversion) however can be applied as well, since such a system can be obtained more easily and still generates a reasonably good activation field.

In an aspect of the invention the identification system further comprises dummy modules and/or passive identification modules arranged in a pattern with said identification modules. The dummy modules simply complete the pattern of the identification system and do neither comprise an antenna arrangement for generating the activation field nor have a decoder unit for processing the response signal from the tags. Further, for a suitable pattern, not every module in the system necessarily needs to transmit an activation signal. At present, it is the impression of the inventors that the identification modules not only generate an activation signal adequate for their own benefit, but that the activation signal is also present outside the boundaries of that identification module. Accordingly, one or more modules outside these boundaries might not need to transmit an activation signal, said modules here being referred to as passive identification modules. These passive identification modules, able to process the response signal, are less expensive and accordingly result in a lower overall costs for the identification system.

The obtained identification data in the identification module may be transmitted to a computer unit in several ways. In an aspect of the invention, substantially each identification module and passive identification module have data transmission lines to transfer identification data from adjacent identification modules. In another aspect of the invention each module may communicate directly with the computer unit over wireless connections. Combinations of both aspects form an aspect of the invention well. In yet another aspect of the invention, the identification system comprises an additional module not used for identification of passing tags itself that wirelessly receives the identification data of the identification system. In a particularly interesting aspect of the invention, the identification data wirelessly hop automatically between the various identification modules of the identification system. This is possible since identification modules of the system mutually can be considered as forming tag—identification module systems and in some communication protocols for such systems, e.g. ISO 18092, data bits may carry the identification data between the identification modules by hopping. Moreover, synchronization of the activation signals of several identification modules can be accomplished in this way.

In an aspect of the invention an identification system is proposed to identify a passive RFID tag passing said system and transmitting a response signal, said identification system comprising a plurality of identification modules, wherein each identification module comprises an antenna arrangement for receiving said response signal, a decoder unit arranged to process said response signal from said passive RFID tag to obtain identification data of said tag; a communication unit arranged for data exchange with another of said plurality of identification modules, and at least one data output for said identification data of said passive RFID tag. In contrast with the previous embodiments, the activation of the tags is not a function for the identification modules. Consequently, these identification modules are less complex. Furthermore, the energy consumption for the total identification system is reduced and synchronization between the identification modules to obtain an adequate activation field can be omitted. The invention also relates to these identification modules as such.

It should be appreciated that the units, e.g. the decoder unit, the communication unit, the synchronization unit, the timer and the memory module, identified in the above described identification modules and identification systems as separate entities can be combined in a single unit or be distributed over one or more units while performing the function assigned to that unit.

In an aspect of the invention, a sports shoe is proposed comprising a sole and foot housing, wherein at least one of said sole and said foot housing has an integrated passive RFID tag. Preferably this tag is a high frequency passive RFID tag, such as a 13.56 MHz tag. Such high frequency passive RFID tags are relatively inexpensive and small (as compared to low frequency RFID tags) enabling such tags to be integrated in a shoe component. Alternatively, the tag can be provided under the inner sole of the shoe, such that it is disposable after the race. High frequency passive RFID tags are off-the-shelf products, available in printed form on a roll.

These tags, when integrated in the shoe, accordingly are brought into close proximity with one or more flat element identification modules when the participant passes the identification system positioned on a track, and consequently an adequate sports timing system using inexpensive tags is obtained. Moreover, the close proximity of the tag to the system allows the power of the activation signal to remain below the level requiring an official license.

### BRIEF DESCRIPTION OF THE DRAWINGS

FIGS. 1A and 1B display statistical data of the New York City marathon of 2002 as an example of a mass event;

FIG. 2 shows a schematic illustration of an identification system according to a first embodiment of the invention;

FIGS. 3A and 3B show schematic illustrations of a passive RFID tag and a shoe having an integrated passive RFID tag in an aspect of the invention;

FIG. 4 shows a schematic illustration of the signal transfer between a passive RFID tag and an identification module in an aspect of the invention;

FIGS. 5A and 5B schematically show an alternative configuration for an identification module in an aspect of the invention;

FIG. 6 shows a schematic illustration of an identification system according to a second embodiment of the invention;

FIG. 7 shows a schematic illustration of an identification system according to a third embodiment of the invention;

FIG. 8 shows a schematic illustration of an identification system according to a fourth embodiment of the invention;

FIG. 9 shows a schematic illustration of an identification system according to a fifth embodiment of the invention, and

FIG. 10 shows a schematic illustration of an identification system according to a sixth embodiment of the invention.

### DETAILED DESCRIPTION OF ILLUSTRATIVE EMBODIMENTS

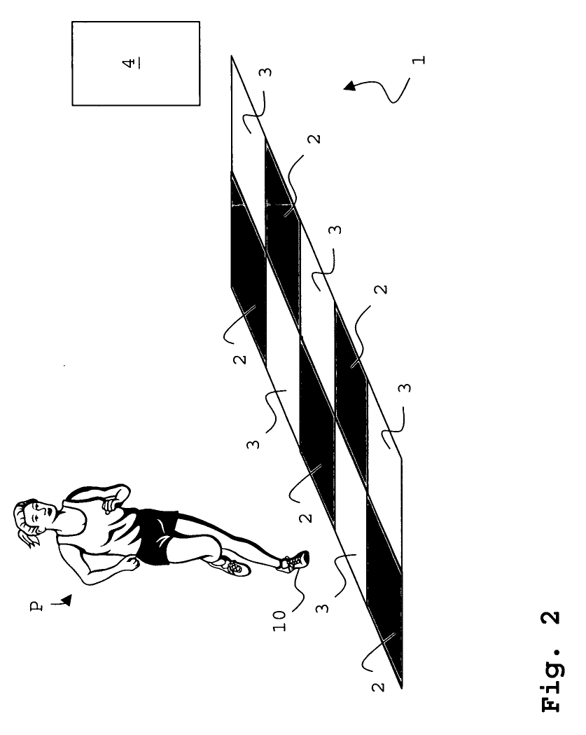

FIG. 2 shows a schematic illustration of an identification system 1 according to a first embodiment of the invention. A participant P of a mass running event is about to pass the identification system 1. The identification system 1 can be provided as a sports timing system for a running track, e.g. on the start line and finish line. Intermediate positions to obtain intermediate times are envisaged as well.

The identification system 1 comprises a plurality of identification modules 2, hereinafter also referred to as tiles, arranged in a pattern with further optional dummy modules 3 and a computer unit 4 in communicative connection with the identification system 1. The dummy modules 3 may be tiles as well.

It is considered that the dimensions of the tiles 2, 3 are in a range between 20×20 centimeters and 100×100 centimeters, e.g. 50×50 centimeters. The height of the tiles 2, 3 amounts to several centimeters, allowing the participant P to easily step on the tiles 2, 3 in passing the identification system 1. The material of the tile 2, 3 should be such that it has a reasonable wear resistance and does not detrimentally influence the signal communication for the identification system 1.

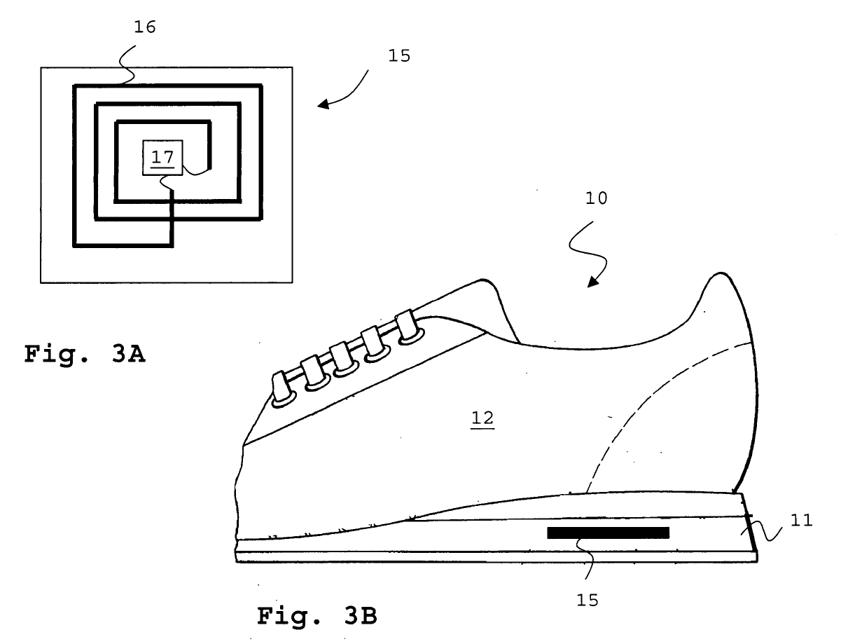

The participant P wears a sporting shoe 10, shown in detail in FIG. 3B, comprising a sole 11 and a foot housing 12. The sporting shoe 10 has an integrated 13.56 MHz passive RFID tag 15, i.e. a passive high frequency tag. Such tags 15 are inexpensive and small as compared to low frequency tags and can accordingly be integrated in the shoe 10, e.g. in the sole 11 or under the removable inner sole (not shown). Integration in the sole 11 has the advantage of an optimal signal coupling between the tag 15 and the tile 2. These tags 15 have an adequate range and are reliable, even under humid conditions. Both shoes 10 of the participant P may comprise a tag 15.

A schematic illustration of the passive RFID tag 15, comprising an antenna 16 and a chip 17, is displayed in FIG. 3A. The chip 17 has stored identification data for the tag 15. These data are used for registering passing of identification system 1 by the participant P. Passive high frequency RFID tags 15 are generally known in the art and are therefore considered to need no further introduction here.

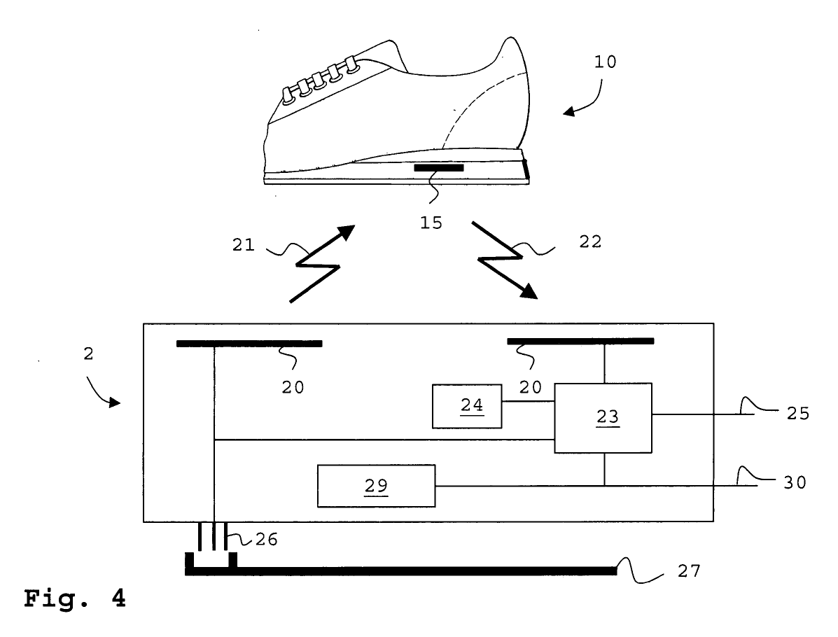

FIG. 4 shows a schematic illustration of the signal transfer between a passive RFID tag 15 integrated in the shoe 10 and a tile 2 of an identification system 1 in an aspect of the invention. The tile 2 comprises an antenna arrangement 20 that has a transmitter portion for transmitting an activation signal 21 for the tag 15 and a receiving portion for receiving a response signal 22 from the tag 15. In the art, the activation signal 21 is often referred to as an interrogation signal. Apart from activation, this signal may also transmit messages to the tag 15, such as instructions for the tag not to send response signals 22. The frequency of the activation signal 21 is set at 13.56 MHz for the 13.56 MHz passive RFID tag 15 worn by the participant P in his shoe 10. When the participant P approaches the tile 2 to come into close proximity, the tag 15 is activated and returns the response signal 22 in a known manner. Close proximity typically means a range from near zero to several tens of centimeters.

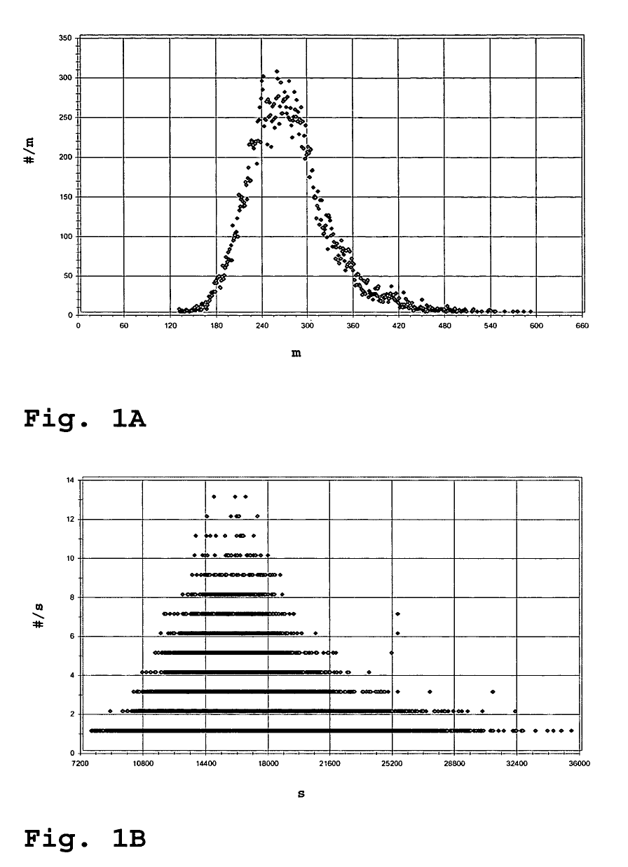

The response signal 22 is modulated as to contain the identification data of the tag 15, stored in the chip 17. The tile 2 comprises a decoder or RFID reader 23, known in the art as such, that processes the response signal 22, or a signal derived associated to the response signal, to extract the identification data and store this identification data in a memory module 24 together with a time stamp. As such the tile 2 ‘knows’ that participant P passed the tile 2 at time t. These identification data can be transmitted to the computer unit 4 (see FIG. 1) via data output 25. The tile 2 may have several data outputs 25 to enable data transfer to other tiles 2 in the system 1.

It is noted that the time t may be a relative time and may differ from the time that the tile 2 transmits the identification data to another tile 2 or the computer unit 4. The tile 2 should only register this time difference with appropriate accuracy. If the identification data hop via further tiles 2,3, as explained below in more detail for some embodiments, additional time differences may be added. Finally, the identification data have an accumulated time difference that may be recalculated by a unit having available the absolute time, such as the computer unit 4, to obtain the time that the tag 15 passed.

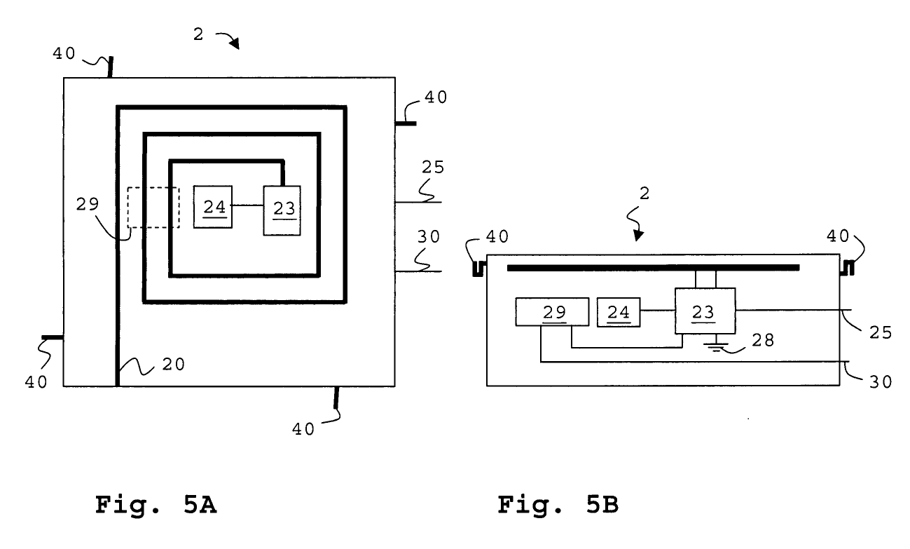

The identification module 2 in principle may be a self functioning unit. The RFID reader 23 may also control the activation signal 21 generated from the antenna structure 20. Power can be supplied in various ways. The tile 2 may e.g. have a connector 26 to connect with a power supply cable 27. This power supply cable 27 may be shared with other tiles 2. In an embodiment of the invention the power supply cable 27 may cooperate with the connectors 26 of various tiles 2 both to supply power and to mechanically connect the tiles 2 with each other. Alternatively, the tile 2 may have its own power supply 28, as shown in FIG. 5B.

The tile 2 further has a communication unit 29 for data exchange with another tile 2 and a data input 30. The communication unit 29 may, inter alia, perform the function of a synchronizing unit to exchange synchronization data between the various tiles 2 of the identification system 1 via e.g. data output 25. Preferable phase lags between the activation signals 21 of adjacent tiles 2 include the range of 60-90°. A phase lag in this range results in a substantially homogeneous activation field, i.e. the activation field has a comparable strength at each distance over the tiles 2. A phase lag of 0° (in phase) or 180° (phase inversion) however can be applied as well, since such a system can be obtained more easily and still generates a reasonably good activation field.

As the tiles 2 typically are modules of a system 1 comprising a plurality of such tiles 2, each tile 2 may have more than one data input 30.

It should be appreciated that the units of the tile 2, such as the reader 23, the memory/timer 24 and the communication unit 29, described above as separate entities can be combined in a single unit or be distributed over one or more units while performing the same function.

FIGS. 5A (top view) and 5B (side view) show a schematic illustration of a tile 2, wherein the antenna arrangement 20 is used both to transmit the activation signal 21 and to receive the response signal 22 from the high frequency passive RFID tag 15. The tile 2 has its own power source 28. Further, the tile 2 has mechanical connection means 40 to connect the tile 2 with adjacent tiles 2 or 3. It should be appreciated that other forms of creating or positioning the individual tiles 2, 3 into a unitary identification system 1 fall under the scope of the present invention. The other components of the tile 2 are identical to the tile 2 discussed with reference to FIG. 4 and bear identical reference numbers.

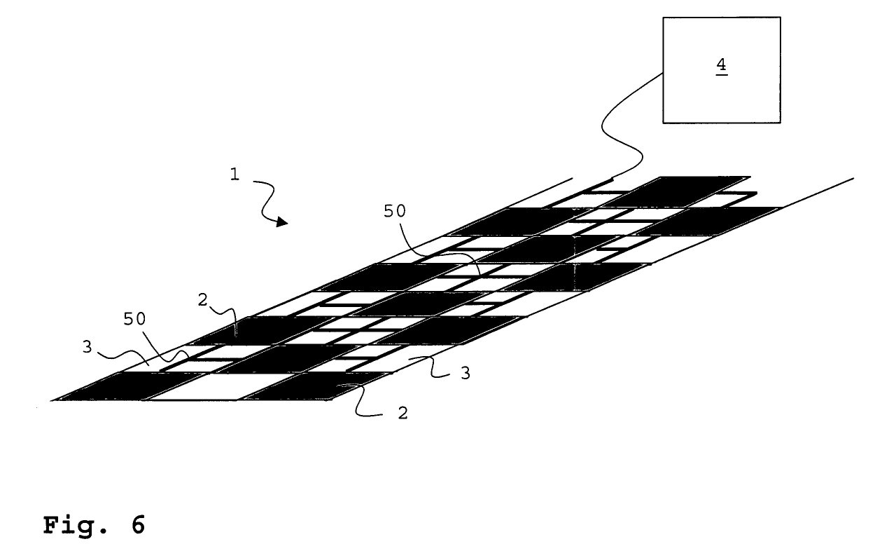

FIG. 6 shows an identification system 1 wherein an extended pattern of tiles 2 and 3 is formed. Such patterns are easily formed, extended or modified due to the modular nature of the identification system 1. Scalability is obtained as no wired connections are necessary for each tile 2 to obtain the identification data of the tag 15. Considerations relevant in determining the pattern of tiles include minimizing the possibility that participants P are not registered, maximizing the use of activation signals for identification modules 2 and minimizing the number of such modules 2. Relevant parameters are the number of participants expected to pass the system 1 per unit of time and the allowable fail rate for identifying a tag 15.

It should be appreciated that the use of dummy modules 3 is not necessary. In principle the identification system 1 may only use the identification modules 2. However the use of dummy tiles 3 is advantageous out of cost considerations.

In FIG. 6, data transfer between the tiles 2, 3 is by wired connections 50 using the data outputs 25 and inputs 30 discussed previously. By transferring the identification data via the tiles 2 towards the computer unit 4, external wired connections for each tile 2 to the computer unit 4 can be omitted, thereby increasing the scalability of the system 1. The data transfer can be controlled by the communication unit 29 (see FIGS. 4 and 5B). Accordingly, the computer unit 4 can e.g. display the results of the race, wherein the passing time for each tag 15, corresponding to a participant P, is listed. Instead of wired connections 50 between the tiles 2, 3, a data bus structure may be applied for making available the data to the computer unit 4.

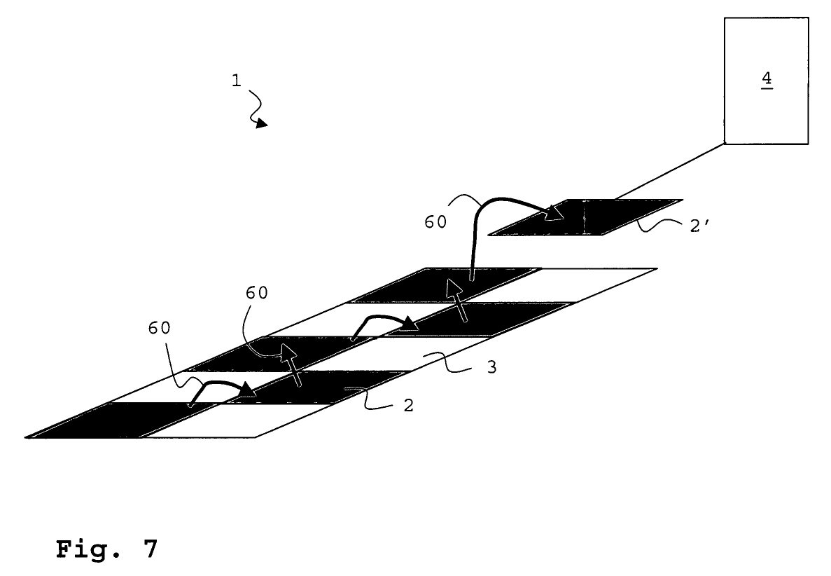

In a particularly advantageous embodiment, shown in FIG. 7, the identification data available at a tile 2 are transferred wirelessly via the other tiles 2 of the system 1 to the computer unit 4. This hopping of identification data, indicated by the arrows 60, is possible, since the tiles 2 communicate with each other in a way similar to the communication between a tile 2 and a tag 15 shown in FIG. 4. The protocol used for this communication, e.g. ISO 18092, has data bits to carry the identification data between tiles 2 to the computer unit 4. This process may be controlled by the communication unit 29. In the embodiment displayed in FIG. 7, a tile 2′, not used for identifying the tags 15, collects the identification data of the tags 15, transported by data hopping between the tiles 2, and transfers these data to the computer unit 4.

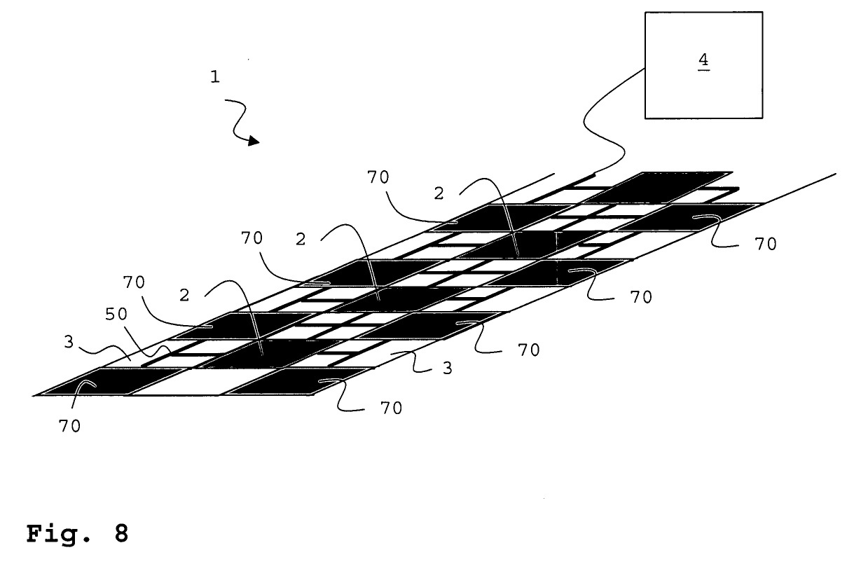

FIG. 8 shows an identification system 1 according to a fourth embodiment of the invention, wherein only few tiles 2 are employed for activating the passing tags 15. The pattern of tiles further includes, apart from the dummy tiles 3, passive identification tiles 70. In contrast with the tiles 2, the activation of the tags 15 is not a function for the passive identification modules 70; the passive identification modules 70 are enabled to ‘listen’ to the response signals of the tag 15 and do not participate in activating the tags. The passive identification modules may be tiles or mats as well. Consequently, these identification modules are less complex. Furthermore, the energy consumption for the total identification system 1 is reduced and synchronization between the identification modules to obtain an adequate activation field can be omitted.

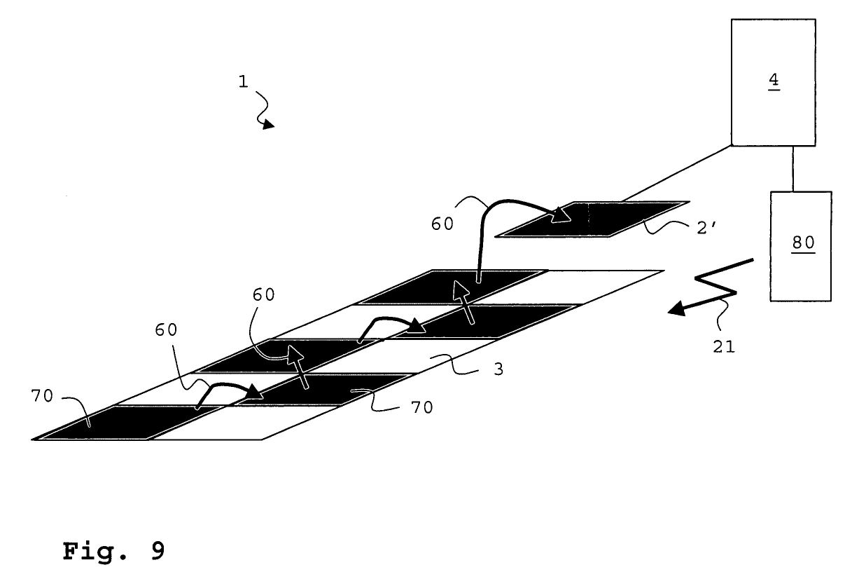

FIG. 9 shows an identification system 1 according to a fifth embodiment of the invention, wherein the activation of the tags 15 is arranged by an external activation source 80. The external activation source 80 generates an activation signal 21, e.g. controlled by the computer unit 4, to trigger a response signal 22 from a tag 15 passing the identification system 1. Accordingly, only passive identification modules 70 are employed to receive the identification data of the passive tag 15 and to transmit these data to the computer unit 4. This data transmission may e.g. be accomplished by data hopping, represented by the arrows 60, between the passive tiles 70 as described above.

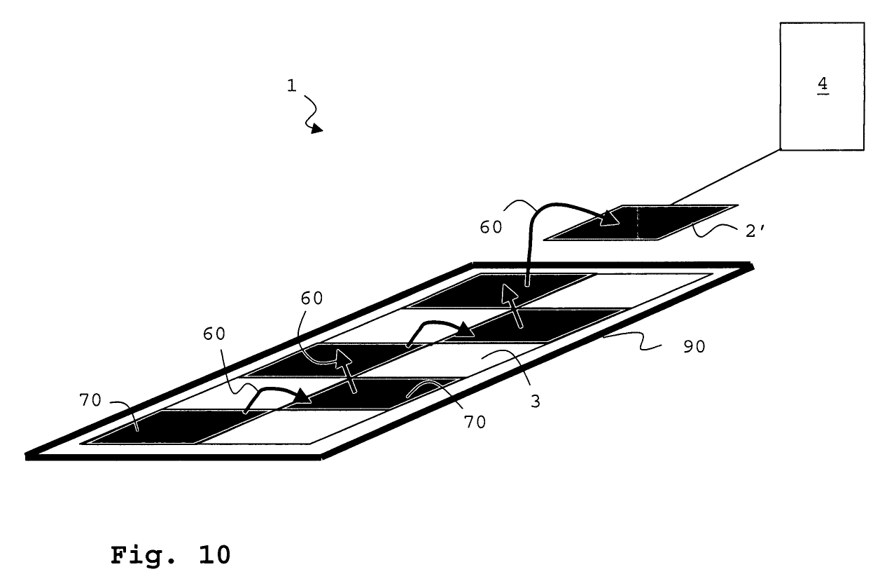

FIG. 10 shows an identification system 1 according to a sixth embodiment of the invention, wherein the identification system 1 comprises passive tiles 70 and dummy tiles 3. Activation of the passing tags 15 is arranged by an activation source 90 on a surface of a running track. The passive identification module 70 are positioned on or over the activation source 90 in the activation field. The activation source 90 may be a loop integrated in the running track or a tile or mat positioned in or on the running track. The tiles 3, 70 may be positioned on top of this mat shaped activation source.

The activation source 90 transmits an activation signal to trigger a response signal from the passing tags 15. The decoders units 23 of the passive tiles 70 extract the identification data from the response signal and forward the identification data, e.g. by wireless hopping 60 between the tiles 70 as controlled by communication units 29 of the tiles 70, to the computer unit 4. If the passive modules 70 can be controlled, the activation field of the activation source 90 positioned under the tiles 70 can be modulated.

It should be appreciated that the above described embodiments, or aspects thereof, may be combined.

What is claimed is:

1. An identification module to identify a passive RFID tag passing said identification module, said identification module comprising:
an antenna arrangement adapted to transmit an activation signal to activate said passive RFID tag and to trigger a response signal from said passive RFID tag;
a decoder unit adapted to process said response signal from said passive transponder to obtain identification data of said passive RFID tag;
a communication unit adapted for data exchange with another identification module, and having at least one data output for said identification data of said passive RFID tag.

2. The identification module according to claim 1, wherein said communication unit comprises a synchronization unit and said data exchange involves synchronization data for transmitting said activation signal.

3. The identification module according to claim 1, wherein said identification module further comprises a timer and a memory module to store said identification data.

4. The identification module according to claim 1, wherein said identification module comprises a flat element, such as a tile or mat, adapted to be positioned on the ground and to be stepped on.

5. The identification module according to claim 4, wherein said flat element comprises mechanical a connector adapted to connect said flat element to one or more other identification modules.

6. An identification system to identify a passive RFID tag passing said system, said identification system comprising:
a plurality of identification modules, wherein at least one identification module comprises an antenna arrangement adapted to transmit an activation signal to activate said passive RFID tag and to trigger a response signal from said passive RFID tag and wherein each identification module comprises:
a decoder unit adapted to process said response signal from said passive RFID tag to obtain identification data of said tag;
a communication unit adapted for data exchange with another of said plurality of identification modules, and having at least one data output for said identification data of said passive RFID tag.

7. The identification system according to claim 6, wherein said system comprises a plurality of identification modules for transmitting activation signals and wherein each communication unit comprises a synchronization unit adapted to synchronize transmission of said activation signal with activation signals of other identification modules of said plurality of identification modules.

8. The identification system according to claim 7, wherein said synchronization units are adapted to synchronize transmission of said activation signal for adjacent identification modules with a phase lag in the range of 60-90°.

9. The identification system according to claim 7, wherein said synchronization units are adapted to synchronize transmission of said activation signal for adjacent identification modules in phase or phase inverted.

10. The identification system according to claim 6, wherein said system comprises dummy modules arranged in a pattern with said identification modules.

11. The identification system according to claim 6, wherein said system comprises dummy modules arranged in a pattern with said identification modules and said dummy modules comprise data transmission lines for data exchange between said identification modules.

12. The identification system according to claim 6, wherein said identification modules are adapted to exchange said identification data wirelessly amongst each other and/or with a computer.

13. The identification system according to claim 6, wherein said identification modules are flat elements, such as a tiles or mats, adapted to be positioned on the ground and to be stepped on.

14. An identification system to identify an RFID tag passing said system and transmitting a response signal, said identification system comprising a plurality of identification modules, wherein each identification module comprises:
an antenna arrangement adapted to receive said response signal;
a decoder unit adapted to process said response signal from said passive RFID tag to obtain identification data of said tag;
a communication unit adapted for data exchange with another of said plurality of identification modules, and having at least one data output for said identification data of said passive RFID tag.

15. The identification system according to claim 14, wherein said identification system further comprises at least one activation source adapted to transmit an activation signal to trigger said response signal.

16. The identification system according to claim 14, wherein said system comprises dummy modules arranged in a pattern with said identification modules.

17. The identification system according to claim 14, wherein said identification system further comprises an activation source adapted to generate an activation field to trigger said response signal, wherein said activation source is positioned on a surface and said plurality of identification modules are position on or over said activation source in said activation field.

18. An identification module to identify an RFID tag passing said identification module and transmitting a response signal, said identification module comprising:
an antenna arrangement adapted to receive said response signal;
a decoder unit adapted to process said response signal from said passive transponder to obtain identification data of said passive RFID tag;
a communication unit adapted for data exchange with another identification module, and having at least one data output for said identification data of said passive RFID tag.

19. A sports shoe comprising a sole and foot housing, wherein at least one of said sole and said foot housing has an integrated passive RFID tag.

20. The sports shoe according to claim 19, wherein said passive RFID tag is a high frequency passive RFID tag.
